(19) United States
(12) Patent Application Publication
(10) Pub. No.: US 2014/0001901 A1
(43) Pub. Date: Jan. 2, 2014

(54) ELECTRIC MOTOR WITH A REDUNDANT SEAL ARRANGEMENT

(71) Applicants: Adam M. Finney, Rockford, IL (US); Roy D. Rasmussen, Janesville, WI (US); Aaron M. Finke, Janesville, WI (US)

(72) Inventors: Adam M. Finney, Rockford, IL (US); Roy D. Rasmussen, Janesville, WI (US); Aaron M. Finke, Janesville, WI (US)

(21) Appl. No.: 13/535,941

(22) Filed: Jun. 28, 2012

(51) Int. Cl. H02K 5/12; H02K 15/00

(52) U.S. Cl. 310/88; 29/596

(57) ABSTRACT

An electric motor has a primary and a secondary seal isolating a rotor cavity from a stator cavity.

### BACKGROUND OF THE INVENTION

The present disclosure relates generally to electric motors, and specifically to a sealing configuration within an electric motor.

Conventional electric motors, such as those used on board an aircraft, use a rotor/stator configuration in which electric power passing through the stator generates an electromagnetic field, which in turn causes a physical rotation of the rotor. The rotor is coupled to an output shaft and allows rotational power to be translated to a mechanical system connected to the output shaft. In some conventional designs, the rotor cavity includes a fluid that is used to cool and lubricate the rotor. This fluid is referred to as a working fluid. The working fluid is pumped throughout the aircraft by the motor. In these designs, a seal is positioned between the rotor cavity and the stator cavity to prevent the working fluid from leaking into the stator cavity and damaging or destroying the stator components.

It is understood that the material used to construct the seal will gradually corrode, resulting in the eventual failure of the seal. When the seal fails, the working fluid is introduced into the stator cavity and will rapidly corrode the stator components. When this occurs motor failure is imminent. Furthermore, conventional motor designs provide no indication that the seal is leaking, and often the first sign of a problem is when the motor has become inoperable and irreparable.

### SUMMARY OF THE INVENTION

Disclosed is an electric motor having a rotor in a rotor cavity; a stator in a stator cavity, wherein the stator is arranged circumferentially about the rotor; a stator sleeve isolating the stator cavity from the rotor cavity; a first primary seal within the rotor cavity, wherein the first primary seal is operable to prevent a working fluid within the rotor cavity from exiting the rotor cavity; and a first secondary seal within the stator cavity, wherein the secondary seal is operable to prevent a working fluid within the rotor cavity from entering the stator cavity.

Also disclosed is, a method for repairing an electric motor including the steps of identifying the presence of a leaking seal within the motor by identifying a working fluid leaking from at least one weep hole; removing at least one of an end cap and a mounting plate of the motor; replacing the leaking seal; and reattaching the at least one of the end cap and the mounting plate.

These and other features of this application will be best understood from the following specification and drawings, the following of which is a brief description.

### BRIEF DESCRIPTION OF THE DRAWINGS

FIG. 1 illustrates an isometric view of an electric motor.

FIG. 2 illustrates a cross-sectional view of the electric motor of FIG. 1.

### DETAILED DESCRIPTION

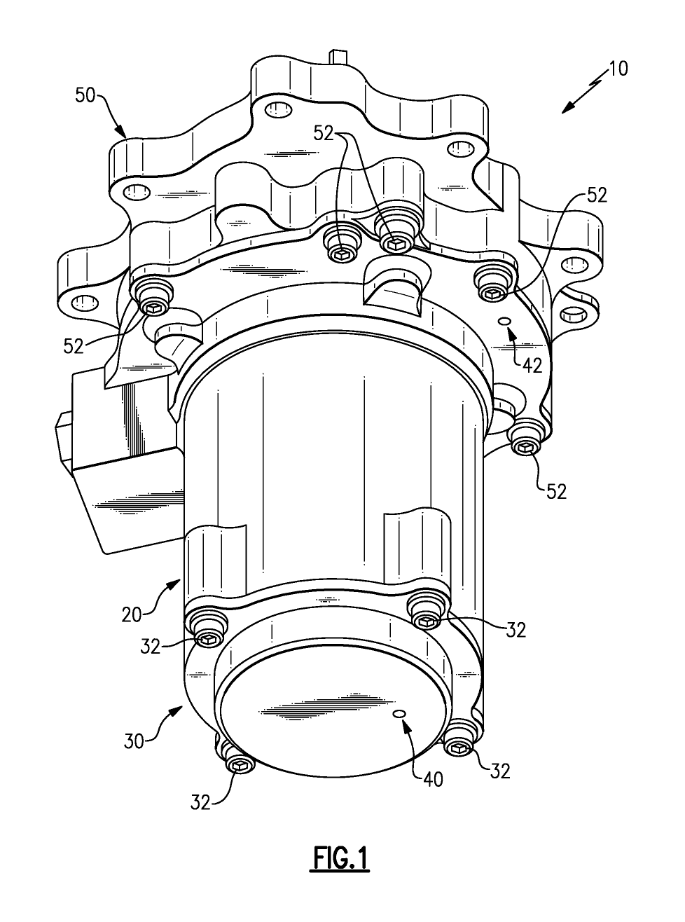

FIG. 1 illustrates an isometric view of an electric motor 10. The motor 10 is contained within a substantially cylindrical motor housing 20. An end cap 30 encloses one axial end of the motor 10, and a mounting plate 50 encloses an axial end of the motor 10 axially opposite the end cap 30. The end cap 30 is fastened to the motor housing 20 using multiple fasteners 32. The mounting plate 50 is fastened to the motor housing 20 using multiple fasteners 52.

Each of the end cap 30 and the motor housing 20 includes a weep hole 40, 42. The weep holes 40, 42 allow a working fluid that has leaked through an internal rotor cavity seal to exit the motor 10 without damaging the stator components. The weep holes 40, 42 are aligned axially, thereby allowing gravity to pull the working fluid out of the weep hole 40, 42. In alternate motor mounting configurations, the weep holes 40, 42 can be oriented in another direction, thereby allowing gravity to drain the working fluid out of the motor housing 20 and the end cap 30.

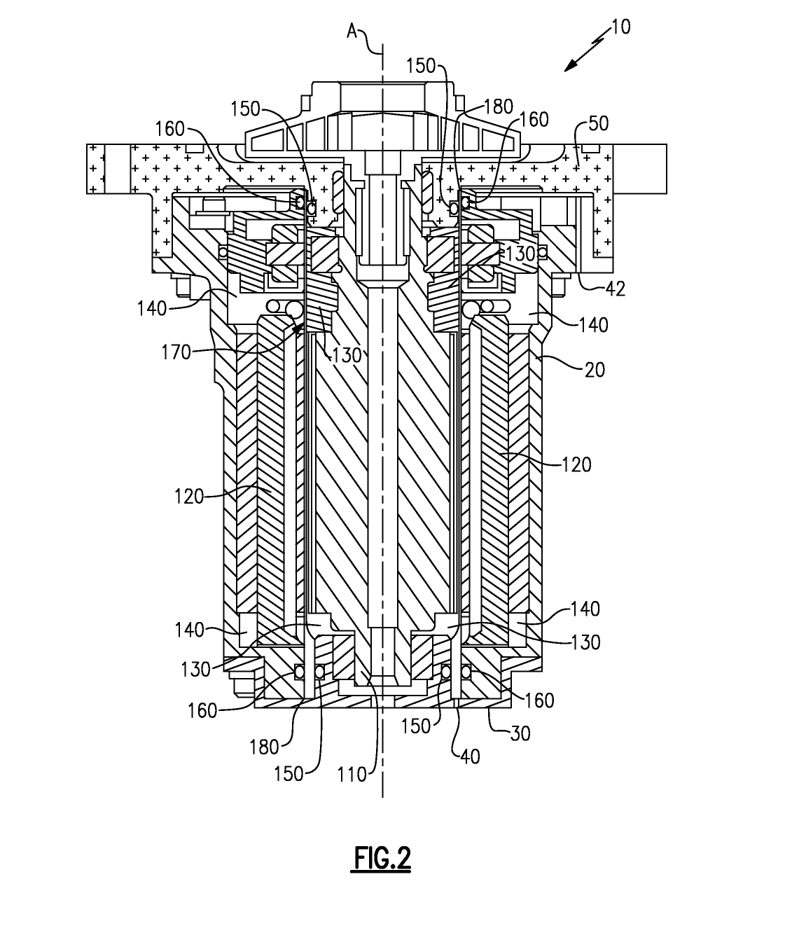

Turning now to FIG. 2, with continued reference to FIG. 1, a cross-sectional view of the motor 10 of FIG. 1 is illustrated. Within the motor housing 20 is a stator cavity 140 containing a stator 120. Radially inward from the stator cavity 140 is a rotor cavity 130 containing a rotor 110. Separating the stator cavity 140 from the rotor cavity 130 is a stator sleeve 170. On each axial end of the stator sleeve 170 is a primary seal 150 and a secondary seal 160. The primary seal 150 is in the rotor cavity 140 and prevents a working fluid in the rotor cavity 130 from leaking out of the rotor cavity 130. The secondary seal 160 is in the stator cavity 140. In the case that the primary seal 150 becomes corroded and begins leaking, the second seal 160 prevents the working fluid within the rotor cavity 130 from entering the stator cavity 140, thereby protecting the components within the stator cavity 140.

Between each of the primary seals 150 and their corresponding secondary seals 160 is a gap 180 defined by the stator sleeve 170 and the end cap 30 or the mounting plate 50. Each of the gaps 180 is similarly connected to a corresponding weep hole 40, 42. In this way, a working fluid that leaks through the primary seal 150 from the rotor cavity 130 is blocked by the secondary seal 160 and accumulates in the gap 180. After accumulating, the working fluid is drawn out the weep hole 40, 42 and exits the motor 10. Due to the orientation of the weep holes 40, 42, and the mounting orientation of the motor 10, gravity provides the force required to draw the working fluid out of the weep holes 40, 42.

The weep hole 40, 42 arrangement further facilitates repair and maintenance of the motor 10 by providing a visual indication of a failing internal primary seal 150 without requiring the motor 10 to be disassembled. As the weep holes 40, 42 on the motor 10 are visible during an inspection, an inspector will notice working fluid leaking out of the weep holes 40, 42 when the primary seal 150 has begun to fail. The inspector can then note the leaking working fluid and the motor 10 can be scheduled for replacement before the motor 10 has been rendered inoperable.

Alternatively, the motor 10 can be scheduled for repair, thereby allowing the life span of the motor 10 to be extended. To repair a leaking primary seal 150, the end cap 30 or the mounting plate 50 corresponding to the weep hole 40, 42 weeping working fluid is removed from the motor 10. As the primary seal 150 is located between the stator sleeve 170 and the end cap 30 or between the stator sleeve 170 and the mounting plate 50, removal of the end cap 30 or the mounting plate 50 provides access to the seal 150 without requiring a complete reconstruction of the motor 10.

In some example motors 10, such as the illustrated example motor 10, the stator sleeve 170 is glued or epoxied in place. In alternate examples, the stator sleeve is not glued and the secondary seal 160 can be accessed by the additional removal of the stator sleeve 170. Motors built according to the alternate example can include replacing the secondary seal 160 as part of the maintenance.

Each of the primary seals 150 and the secondary seals 160 in the illustrated example motor 10 are O-ring type seals. Alternatively, any stiff non-rotating seal type can be used to similar effect. In further alternative embodiments, additional weep holes 40, 42 can be used in place of the singular weep holes 40, 42 on each axial end of the motor 10, as illustrated in the example embodiment. Additional weep holes can allow working fluid to be drained from the gap 180 quicker in the case of a leaking primary seal 150, thereby lengthening the operational time of the motor 10 after the primary seal 150 has begun to leak and increasing a repair/replace time window before the motor 10 fails.

Although an embodiment of this invention has been disclosed, a worker of ordinary skill in this art would recognize that certain modifications would come within the scope of this invention. For that reason, the following claims should be studied to determine the true scope and content of this invention.

1. An electric motor comprising:
a rotor in a rotor cavity;
a stator in a stator cavity, wherein said stator is arranged circumferentially about said rotor;
a stator sleeve isolating said stator cavity from said rotor cavity;
a first primary seal within said rotor cavity, wherein said first primary seal is operable to prevent a working fluid within said rotor cavity from exiting said rotor cavity; and
a first secondary seal within said stator cavity, wherein said secondary seal is operable to prevent a working fluid within said rotor cavity from entering said stator cavity.

2. The electric motor of claim 1, wherein said first primary seal and first secondary seal are separated by said stator sleeve.

3. The electric motor of claim 1, further comprising a weep cavity fluidly connected to said first primary and said first secondary seals, wherein said weep cavity is operable to collect a working fluid that has passed through said first primary seal.

4. The electric motor of claim 3, further comprising at least one weep hole connected to said weep cavity, wherein said weep hole is operable to drain said working fluid from said weep cavity.

5. The electric motor of claim 3, wherein said weep cavity is a gap defined by one of a stator sleeve and an end cap or a stator sleeve and a mounting plate.

6. The electric motor of claim 1, further comprising a second primary seal within said rotor cavity, wherein said second primary seal is operable to prevent fluid within said rotor cavity from exiting said rotor cavity; and
a second secondary seal within said stator cavity, wherein said second secondary seal is operable to prevent said working fluids from entering said stator cavity.

7. The electric motor of claim 6, wherein said second primary and second secondary seals are axially opposite said first primary and first secondary seals.

8. The electric motor of claim 6, further comprising a second weep cavity fluidly connected to said second primary and second secondary seals, wherein said second weep cavity is operable to collect said working fluid that has passed through said second primary seal.

9. The electric motor of claim 8, further comprising a weep hole connected to said weep cavity wherein said weep hole is operable to drain fluid from said cavity.

10. The electric motor of claim 1, wherein said first primary seal and said first secondary seal are stiff, nonrotating seals.

11. The electric motor of claim 10, wherein at least one of said first primary seal and first secondary seal is an O-ring type seal.

12. A method for repairing an electric motor comprising the steps of:
identifying the presence of a leaking seal within said motor by identifying a working fluid leaking from at least one weep hole;
removing at least one oven end cap and a mounting plate of said motor;
replacing said leaking seal; and
reattaching said at least one of said end cap and said mounting plate.

13. The method of claim 12, wherein said step of replacing said leaking seal comprises removing a stiff nonrotating primary seal and replacing said stiff nonrotating primary seal with a new stiff nonrotating primary seal.

14. The method of claim 12, wherein said step of removing said at least one of an end cap and a mounting plate of said motor further comprising removing a stator sleeve of said motor, thereby allowing a secondary seal to be replaced.
